(19) United States
(12) Patent Application Publication
(10) Pub. No.: US 2025/0261287 A1
(43) Pub. Date: Aug. 14, 2025

(54) PERFECT FONDUE/BOURGUIGNONNE WITH TEMPERATURE CONTROL

(71) Applicant: WHIRLPOOL CORPORATION, BENTON HARBOR, MI (US)

(72) Inventors: Andrea Gallivanoni, Casorate Sempione (IT); Andrea Gasparoni, Comerio (IT); Alessandro Gigante, Varese (IT); Matteo Mancino, Milano (IT); Daniele Masi, Travedona Monate (IT); Gian Mauro Musso, Portogruaro (IT); Annalisa Pacioni, Bresso (IT); Collin Andrew Stipe, West Unity, OH (US)

(73) Assignee: WHIRLPOOL CORPORATION, BENTON HARBOR, MI (US)

(21) Appl. No.: 18/440,370

(22) Filed: Feb. 13, 2024

(51) Int. Cl. H05B 6/06; H05B 6/12

(52) U.S. Cl. CPC H05B 6/062; H05B 6/1209; H05B 2213/07

(57) ABSTRACT

An induction heating system includes an induction heater, a user interface for setting a desired temperature value of induction heater, and a cooking vessel. The cooking vessel is formed of an induction-compatible material and includes a base, an exterior wall, and an interior surface. A control system is configured to receive the desired temperature value of the induction heater, estimate an actual temperature value of the cooking vessel, and compare the estimated temperature value with the desired temperature value. If a difference between the estimated and desired temperature values is outside of a predetermined threshold, the control system adjusts the induction heater until the difference between the estimated and desired temperature values is within the predetermined threshold.

### FIELD OF THE DISCLOSURE

The present disclosure generally relates to an induction heating system and a method of maintaining food within an optimal temperature.

### BACKGROUND

Specialty food heating appliances are typically designed to cook and/or heat a single type of food. Many specialty food heating appliances utilize an open flame or an electric heater that can be hard to adjust to an optimized temperature. In addition, these traditional heating systems typically include linear heating protocols, such that some foods, like fondues, are heated at the same temperature both during a melting and/or warming process and a maintenance and/or eating process. Linear heating protocols can result in food being heated too slowly or overheated if a cooking process is continuous. In addition, many of these traditional systems rely on temperature settings within the appliance rather than an estimation of an actual temperature.

Accordingly, the present disclosure relates to an induction heating system and a method of maintaining food within an optimal temperature, such as an optimal temperature curve.

### SUMMARY OF THE DISCLOSURE

According to one aspect of the present disclosure, an induction heating system includes an induction heater, a user interface for setting a desired temperature value of an induction heater, and a cooking vessel. The cooking vessel is formed of an induction-compatible material and includes a base, an exterior wall, and an interior surface. A control system is configured to receive the desired temperature value of the induction heater, estimate an actual temperature value of the cooking vessel, and compare the estimated temperature value with the desired temperature value. If a difference between the estimated and desired temperature values is outside of a predetermined threshold, the control system adjusts the induction heater until the difference between the estimated and desired temperature values is within the predetermined threshold.

According to another aspect of the present disclosure, an induction heating system includes an induction heater and a cooking vessel formed of an induction-compatible material and including a base, an exterior wall, and an interior surface. The induction heating system further includes a processor and a memory. The memory contains at least one heating setting for at least one of chocolate fondue, cheese fondue, bourguignonne, and hot pot. When the at least one heating setting is executed by the processor, the processor is caused to estimate an actual temperature value of the cooking vessel, and adjust the induction heater in accordance with the at least one heating setting.

According to yet another aspect of the present disclosure, an induction heating system includes an induction heater, a user interface for setting a desired temperature value associated with at least one heating setting of the induction heater, and a cooking vessel. The cooking vessel is formed of an induction-compatible material and includes a base, an exterior wall, and an interior surface. The induction heating system further includes a processor and a memory. The memory contains at least one heating setting for at least one of chocolate fondue, cheese fondue, bourguignonne, and hot pot. When the at least one heating setting is executed by the processor, the processor is caused to compare the estimated temperature value with the desired temperature value, and, if a difference between the estimated and desired temperature values is outside of a predetermined threshold, adjust the induction heater until the difference between the estimated and desired temperature values is within the predetermined threshold.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic view of an induction heating system, in accordance with an aspect of the present disclosure;

FIG. 2A is a top perspective view of an induction heating system integrated within a pocket in a table, in accordance with an aspect of the present disclosure;

FIG. 2B is a top perspective view of an induction heating system integrated within a table, in accordance with an aspect of the present disclosure;

FIG. 3 is a schematic view of a control system of an induction heating system, in accordance with an aspect of the present disclosure;

FIG. 4 is a graphical representation of a predefined temperature curve for chocolate fondue, in accordance with an aspect of the present disclosure;

FIG. 5 is a graphical representation of a predefined temperature curve for cheese fondue, in accordance with an aspect of the present disclosure;

FIG. 6 is a graphical representation of a predefined temperature curve for bourguignonne, in accordance with an aspect of the present disclosure; and

FIG. 7 is a graphical representation of a predefined temperature curve for a hot pot, in accordance with an aspect of the present disclosure.

The components in the figures are not necessarily to scale, emphasis instead being placed upon illustrating the principles described herein.

### DETAILED DESCRIPTION

The present illustrated embodiments reside primarily in an induction heating system and a method of maintaining food within an optimal temperature. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

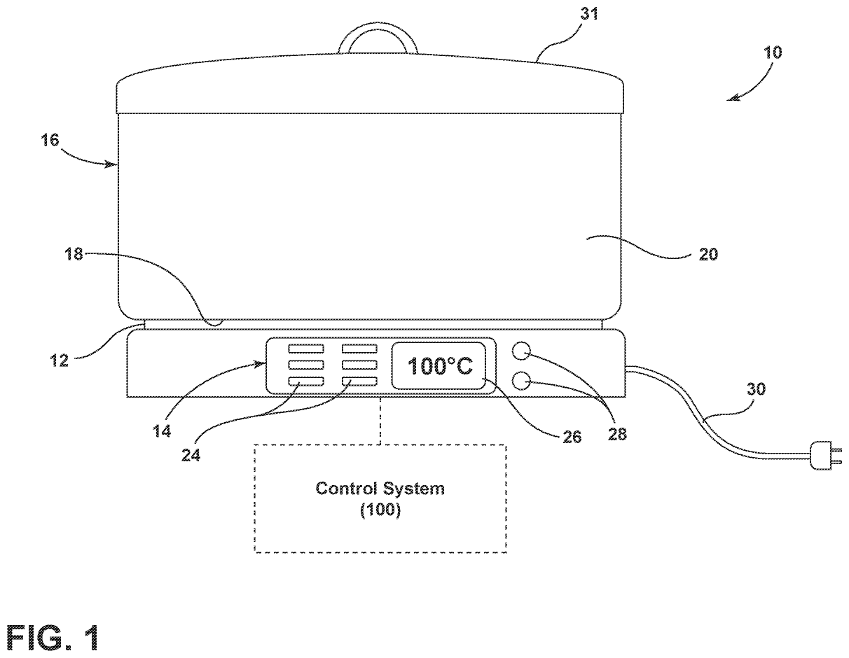

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer and/or user, and the term “rear” shall refer to the surface of the element further from the intended viewer and/or user. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

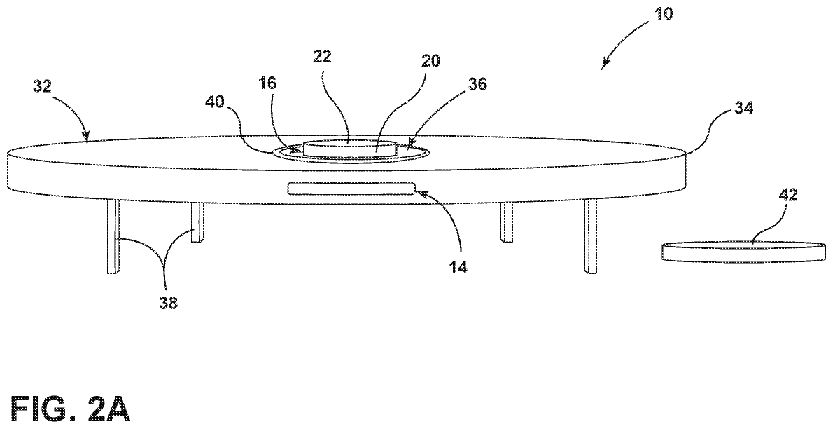

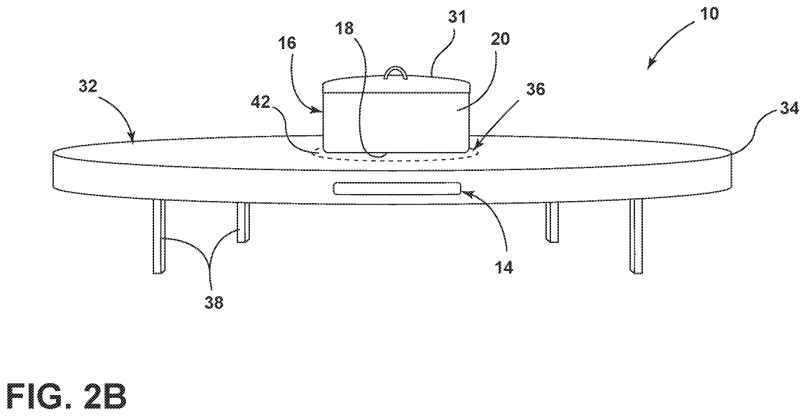

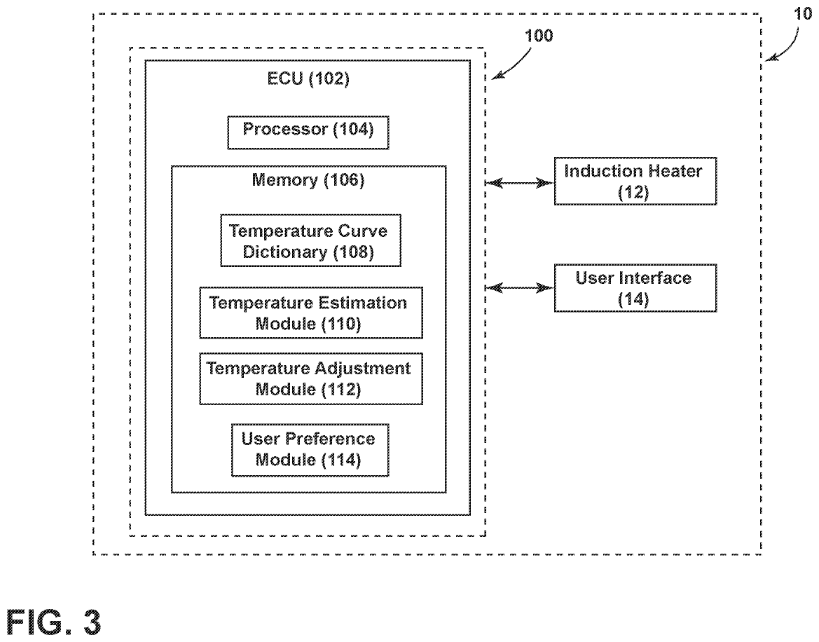

Referring to FIGS. 1-3, reference numeral 10 generally designates an induction heating system. The induction heating system 10 includes an induction heater 12, a user interface 14 for setting a desired temperature value “Td” of induction heater 12, and a cooking vessel 16. The cooking vessel 16 is formed of an induction-compatible material and includes a base 18, an exterior wall 20, and an interior surface 22 (FIG. 2A). A control system 100 (FIG. 3) is configured to receive the desired temperature value Td of the induction heater 12, estimate an actual temperature value “Te” of the cooking vessel 16, and compare the estimated temperature value Te with the desired temperature value Td. If a difference between the estimated and desired temperature values Te, Td is outside of a predetermined threshold, the control system 100 adjusts the induction heater 12 until the difference between the estimated and desired temperature values Te, Td is within the predetermined threshold.

With reference now to FIG. 1, the induction heating system 10 may include a plurality of heating settings for two or more, three or more, or each of the chocolate fondue, cheese fondue, bourguignonne, and hot pot. As will be described in greater detail, depending on the type of food being heated (e.g., chocolate fondue, cheese fondue, bourguignonne, or hot pot), each heating cycle may be configured to follow a predefined temperature curve to efficiently warm the food to an optimal temperature and keep the food at the optimal temperature. The predefined temperature curves may include temperature limits depending on the food (e.g., below the burning temperature of chocolate) and a variety of other food specific factors that will be detailed below. Further, it should be appreciated that by utilizing induction technology in the induction heating system 10, the estimated temperature value Te can be obtained without any external temperature probes or temperature sensors in the induction-compatible cooking vessel 16. In this manner, in some embodiments, any number of induction-compatible cooking vessels can be used in addition to the induction-compatible cooking vessel 16. As such, the control system 100 can still perform the functions as outlined herein with any number of different induction-compatible cooking vessels based on the principles of induction technology.

With continued reference to FIG. 1, the user interface 14 may include a variety of user inputs 24, such as buttons, toggles, switches, and the like. The user interface 14 may further include a display 26. In operation, the user inputs 24 may be used for manually setting the desired temperature value Td. In some embodiments, the user inputs may be used for selecting the type of heating cycle associated with the food being heated. The display 26 may generate graphics that include the desired temperature value Td, the estimated temperature value Te, both the desired temperature value Td and the estimated temperature value Te, a difference between the desired temperature value Td and the estimated temperature value Te, and/or combinations thereof. In some embodiments, the display 26 may generate graphics associated with the stage of the heated cycle, for example, warming/melting, and maintenance/ready to eat. In some embodiments, the display 26, a light 28, the like, and/or combinations thereof may notify a user if the heating cycle is warming, maintenance, and/or if there is a difference between the desired temperature value Td and the estimated temperature value Te. For example, the light 28 (e.g., a plurality of lights) may illuminate a first color during warming and a second color during maintenance. The induction heating system 10 includes a power receiving module 30, such as a power cord, a battery, combinations thereof, and/or the like. In some embodiments, such as the induction heating system 10 depicted in FIG. 1, the induction heating system 10 may be a portable unit capable of operating in a variety of environments. In some embodiments, the cooking vessel 16 may include a lid 31. The cooking vessel 16 may be statically connected or moveable with respect to the induction heater 12. In some embodiments, the interior surface 22 may include a non-stick coating.

With reference now to FIGS. 2A and 2B, in some embodiments, the induction heating system 10 may be coupled with a table 32. More particularly, the induction heating system 10 may be selectively coupled to or statically integrated with the table 32. More particularly, the table 32 may define an outer perimeter 34. The outer perimeter 34 may be a variety of shapes, such as round, oval, square, a polygon (e.g., with three, four, five, six, seven, eight, or more sides), and/or the like. The table 32 may further define a pocket 36 aligned with the induction heater 12. In some embodiments, the pocket 36 may be located centrally within the outer perimeter 34. The table 32 may further include a plurality of legs 38. The legs 38 and/or portions of the table 32 (e.g., within the outer perimeter 34) may be foldable, such that the table 32 can be stored when not in use. The induction heater 12 may be at the bottom of the pocket 36 and the pocket 36 may define a depth such that a top of the cooking vessel 16 is flush with the table 32. It should further be appreciated that, in some embodiments, the induction heater 12 may be located in the pocket 36 and flush with the table 32, inset from the table 32, or extend out from the table 32. In some embodiments, a heat shield 40 surrounds the induction heater 12. The heat shield 40 may be formed from a thermal barrier material that separates the induction heater 12 from other components of the table 32. In still further embodiments, a cover 42 may be utilized to cover the pocket 36 such that the table 32 has the appearance of an uninterrupted top surface. In still further embodiments, such as the table 32 depicted in FIG. 2B, the cover 42 may be statically connected over the pocket 36 and proximate the induction heater 12 and formed of a material that permits the induction heater 12 to heat the cooking vessel 16 through the cover 42. In this manner, when not in use, the table 32 may have the visual appearance of a traditional table.

With reference now to FIG. 3, the control system 100 is schematically illustrated. The control system 100 may include an electronic control unit (ECU) 102. The ECU 102 may include the processor 104 and the memory 106. The processor 104 may include any suitable processor 104. Additionally, or alternatively, the ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid-state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the control system 100. The induction heater 12 and the user interface 14 may therefore be controlled and/or receive instructions from the ECU 102. The memory 106 may therefore include a temperature curve dictionary 108, a temperature estimation module 110, a temperature adjustment module 112, and a user preference module 114.

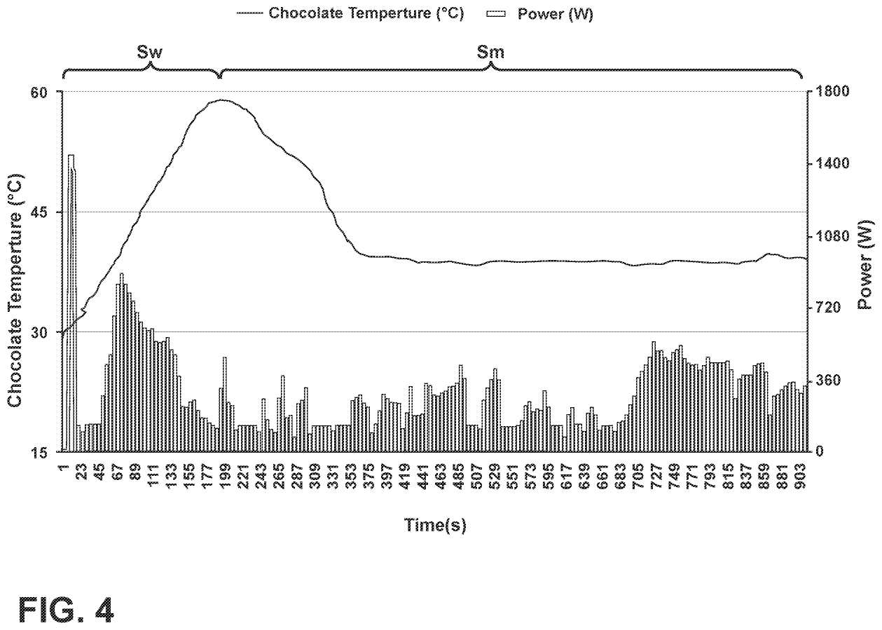

With reference now to FIGS. 4-7, a variety of example predefined temperature curves are illustrated. These predefined temperature curves are each associated with one of the chocolate fondue, cheese fondue, bourguignonne, and/or hot pot heating settings. However, it should be appreciated that heating settings for additional types of foods may be present in the temperature curve dictionary 108. As such, it should further be appreciated that the induction heating system 10 may be capable of heating additional types of foods in addition to the chocolate fondue, cheese fondue, bourguignonne, and/or hot pot. Each or select predefined temperature curves may include a warming segment Sw to optimally heat the food to a temperature/characteristic and a maintenance segment Sm to maintain the food at the temperature/characteristic.

With reference now to FIG. 4, a predefined temperature curve of a heat setting for preparing chocolate fondue is illustrated. The predefined temperature curve for preparing chocolate fondue includes the estimated temperature value Te as a function of both time and power supplied (in Watts) to the induction heater 12. As it relates to chocolate fondue, a temperature of about 55° C. is ideal or optimal for initial melting of the chocolate (e.g., in the warming or melting segment Sw), while a temperature of about 40° C. to about 45° C. is ideal to maintain a melted state (e.g., in the maintenance segment Sm) of the chocolate itself. The induction heating system 10 is configured to (e.g., via the control system 100) follow the predefined temperature curve for optimal texture of the melted chocolate. More particularly, the control system 100 may, upon input by a user, select a predefined temperature curve associated with chocolate fondue via temperature curve dictionary 108, estimate the actual temperature value Te with the temperature estimation module 110, and adjust the power supplied to the induction heater 12 via temperature adjustment module 112 in accordance with the predefined temperature curve. As illustrated, the average value of power supplied to the induction heater 12 in the melting segment Sw may be greater than the average value of power supplied to the induction heater 12 in the maintenance segment Sm.

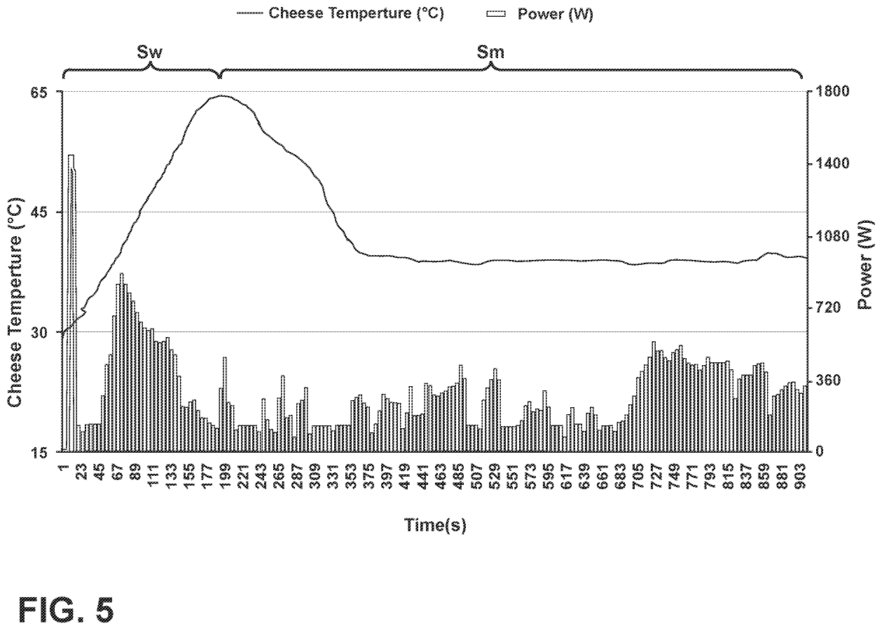

With reference now to FIG. 5, a predefined temperature curve of a heat setting for preparing cheese fondue is illustrated. The predefined temperature curve for preparing cheese fondue may utilize similar ranges as chocolate fondue, depending on the type of cheese. The predefined temperature curve for preparing cheese fondue includes the estimated temperature value Te as a function of both time and power supplied (in Watts) to the induction heater 12. As it relates to cheese fondue, a temperature of about 66° C. is ideal for initial melting of the cheese (e.g., in the warming or melting segment Sw), while a temperature of about 40° C. to about 45° C. is ideal or optimally to maintain a melted state (e.g., in the maintenance segment Sm) of the cheese itself. The induction heating system 10 is configured to (e.g., via the control system 100) follow the predefined temperature curve for optimal texture of the melted cheese. More particularly, the control system 100 may, upon input by a user, select a predefined temperature curve associated with cheese fondue via temperature curve dictionary 108, estimate the actual temperature value Te with the temperature estimation module 110, and adjust the power supplied to the induction heater 12 via temperature adjustment module 112 in accordance with the predefined temperature curve. As illustrated, the average value of power supplied to the induction heater 12 in the melting segment Sw may be greater than the average value of power supplied to the induction heater 12 in the maintenance segment Sm.

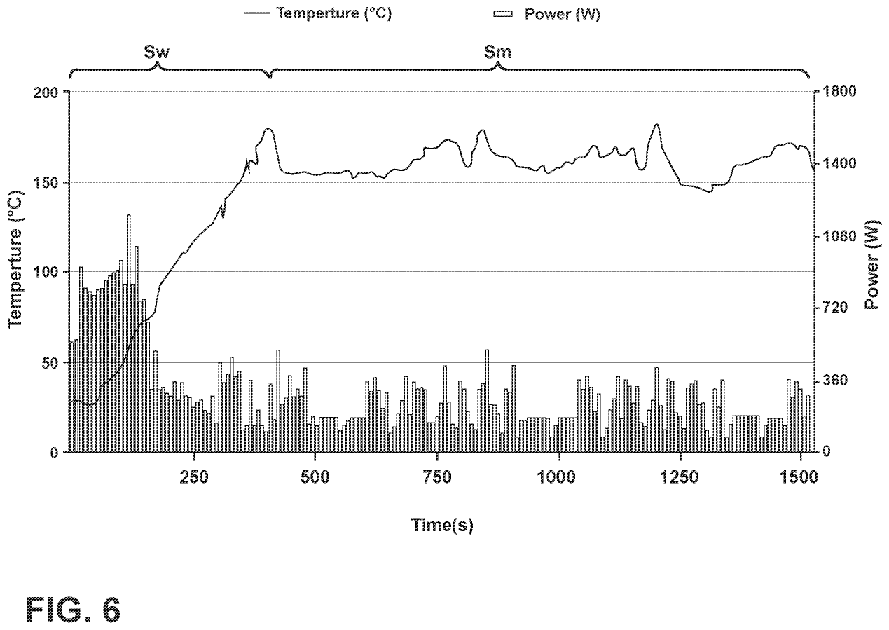

With reference now to FIG. 6, a predefined temperature curve of a heat setting for preparing bourguignonne is illustrated. The predefined temperature curve for preparing bourguignonne includes the estimated temperature value Te as a function of both time and power supplied (in Watts) to the induction heater 12. As it relates to bourguignonne, the oil temperature has to be optimally kept at a much higher value, around 180° C. (e.g., in the warming segment Sw), while a lower power to the induction heater 12 may be ideal to maintain a warmed state (e.g., in the maintenance segment Sm) of the oil itself. The induction heating system 10 is configured to (e.g., via the control system 100) follow the predefined temperature curve for optimal heating and maintaining the oil. More particularly, the control system 100 may, upon input by a user, select a predefined temperature curve associated with bourguignonne via temperature curve dictionary 108, estimate the actual temperature value Te with the temperature estimation module 110, and adjust the power supplied to the induction heater 12 via temperature adjustment module 112 in accordance with the predefined temperature curve. As illustrated, the average value of power supplied to the induction heater 12 in the warming segment Sw may be greater than the average value of power supplied to the induction heater 12 in the maintenance segment Sm.

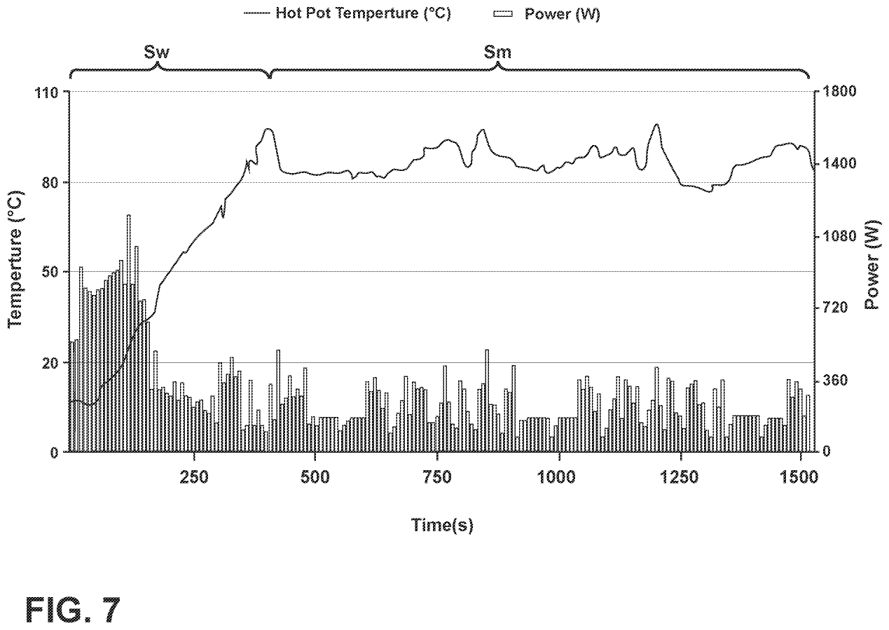

With reference now to FIG. 7, a predefined temperature curve of a heat setting for preparing a hot pot is illustrated. The predefined temperature curve for preparing the hot pot includes the estimated temperature value Te as a function of both time and power supplied (in Watts) to the induction heater 12. As it relates to hot pot, the broth temperature has to be optimally kept around a low boil (e.g., a rolling boil), around 93 to 98° C. (e.g., in the warming segment Sw), while a lower power to the induction heater 12 may be ideal to maintain a warmed state (e.g., in the maintenance segment Sm) of the broth itself. The induction heating system 10 is configured to (e.g., via the control system 100) follow the predefined temperature curve for optimal heating and maintaining the broth. More particularly, the control system 100 may, upon input by a user, select a predefined temperature curve associated with a hot pot via temperature curve dictionary 108, estimate the actual temperature value Te with the temperature estimation module 110, and adjust the power supplied to the induction heater 12 via temperature adjustment module 112 in accordance with the predefined temperature curve. As illustrated, the average value of power supplied to the induction heater 12 in the warming segment Sw may be greater than the average value of power supplied to the induction heater 12 in the maintenance segment Sm.

With reference now to FIGS. 3-7, the warming/melting segment Sw of the various predefined temperature curves allows for the food to be quickly heated to an optimal temperature. Each predefined temperature curve may include a maximum temperature associated with the type of food. The temperature estimation module 110 may be utilized to prevent food from exceeding the maximum temperature and burning, over boiling, smoking, and/or the like. In one aspect of operation, the user may select the desired temperature value Td of the induction heater 12 by choosing a type of food being heated on the user interface 14 and the control system 100 may automatically heat the food in accordance with the predefined temperature curve. In another aspect of operation, the user may select the desired temperature value Td of the induction heater 12 by choosing a specific temperature on the user interface 14 and the control system 100 may automatically heat the food in accordance with the predefined temperature curve. In some embodiments, the control system 100 may be configured to allow a user to choose and/or adjust a temperature setting within a specific range. More particularly, the control system 100 may include an optimal temperature setting or curve (e.g., for the warming segment Sw and the maintenance segment Sm) and allow a user to adjust within 10° C., within 5° C., or another suitable range relative to the optimal setting. The optimal settings for the maintenance segment Sm of the various food types are provided above.

With continued reference to FIGS. 3-7, Regardless of the type of operation, the control system 100 (e.g., the processor 104) may be configured to receive the desired temperature value Td of the induction heater 12, estimate an actual temperature value Te of the cooking vessel 16, and compare the estimated temperature value Te with the desired temperature value Td. If a difference between the estimated and desired temperature values Te, Td is outside of the predetermined threshold (e.g., within 10%, within 5%, within 2%), the control system 100 adjusts the induction heater 12 until the difference between the estimated and desired temperature values Te, Td is within the predetermined threshold. However, the user, via the user interface 14 and user preference module 114, may be configured to bypass and/or modify the predefined temperature curve for any selected desired temperature value Te. For example, if a user wants to adjust a heating setting associated with a specific type of cheese or chocolate, the user can select the desired temperature value Td and the control system 100 can modify the warming segment Sw to quickly obtain the desired temperature value Td while keeping the food under the maximum temperature. The control system 100 may be further configured to modify the maintenance segment Sm to maintain the desired temperature value Td.

The disclosure herein is further summarized in the following paragraphs and is further characterized by combinations of any and all of the various aspects described therein.

According to one aspect of the present disclosure, an induction heating system includes an induction heater, a user interface for setting a desired temperature value of the induction heater, and a cooking vessel. The cooking vessel is formed of an induction-compatible material and includes a base, an exterior wall, and an interior surface. A control system is configured to receive the desired temperature value of the induction heater, estimate an actual temperature value of the cooking vessel, and compare the estimated temperature value with the desired temperature value. If a difference between the estimated and desired temperature values is outside of a predetermined threshold, the control system adjusts the induction heater until the difference between the estimated and desired temperature values is within the predetermined threshold.

According to another aspect, a control system includes a heating setting for at least one of chocolate fondue, cheese fondue, bourguignonne, and hot pot.

According to yet another aspect, a control system includes a processor and a memory, the memory containing instructions for a heating setting that, when executed by the processor, cause the processor to adjust an induction heater in accordance with the heating setting.

According to still yet another aspect, instructions for a heating setting include a predefined temperature curve that has a rate of adjusting the induction heater.

According to another aspect, a heating setting includes a plurality of heating settings for two or more of chocolate fondue, cheese fondue, bourguignonne, and hot pot.

According to yet another aspect, a table includes a pocket and an induction heater is located in the pocket.

According to still yet another aspect, a pocket is sized to accommodate a base of a cooking vessel.

According to another aspect, a perimeter of the table is round.

According to yet another aspect, an interior surface of a cooking vessel includes a non-stick coating.

According to another aspect of the present disclosure, an induction heating system includes an induction heater and a cooking vessel formed of an induction-compatible material and including a base, an exterior wall, and an interior surface. The induction heating system further includes a processor and a memory. The memory contains at least one heating setting for at least one of chocolate fondue, cheese fondue, bourguignonne, and hot pot. When the at least one heating setting is executed by the processor, the processor is caused to estimate an actual temperature value of the cooking vessel, and adjust the induction heater in accordance with the at least one heating setting.

According to another aspect, at least one heating setting includes a maximum temperature, and the processor prevents the induction heater from exceeding the maximum temperature.

According to yet another aspect, at least one heating setting includes a chocolate fondue heating setting with an optimal setting of about 45° C. and a user interface configured to allow a user to adjust the temperature within a range of about 5° C. above and below the optimal setting.

According to yet another aspect, at least one heating setting includes a cheese fondue heating setting with an optimal setting of about 40° C. to 45° C. and a user interface configured to allow a user to adjust the temperature within a range of about 5° C. above and below the optimal setting.

According to another aspect, at least one heating setting includes a hot pot heating setting with an optimal setting of about 93° C. to 98° C. and a user interface configured to allow a user to adjust the temperature within a range of about 5° C. above and below the optimal setting.

According to yet another aspect, at least one heating setting includes a predefined temperature curve that has a melting segment and a maintenance segment, the melting segment including a higher temperature than the maintenance segment.

According to yet another aspect, a table defines an outer perimeter that includes a pocket located substantially centrally within the outer perimeter and an induction heater is located in the pocket.

According to yet another aspect of the present disclosure, an induction heating system includes an induction heater, a user interface for setting a desired temperature value associated with at least one heating setting of the induction heater, and a cooking vessel. The cooking vessel is formed of an induction-compatible material and includes a base, an exterior wall, and an interior surface. The induction heating system further includes a processor and a memory. The memory contains at least one heating setting for at least one of chocolate fondue, cheese fondue, bourguignonne, and hot pot. When the at least one heating setting is executed by the processor, the processor is caused to compare the estimated temperature value with the desired temperature value, and, if a difference between the estimated and desired temperature values is outside of a predetermined threshold, adjust the induction heater until the difference between the estimated and desired temperature values is within the predetermined threshold.

According to another aspect, at least one heating setting includes a predefined temperature curve that has a warming segment and a maintenance segment, the warming segment including a higher temperature than the maintenance segment.

According to yet another aspect, at least one heating setting includes a cheese fondue heating setting and a chocolate fondue heating setting and a warming segment is associated with melting and a maintenance segment is associated with maintaining the cheese or chocolate in a melted state.

According to another aspect, at least one heating setting includes a plurality of heating settings for two or more of the chocolate fondue, cheese fondue, bourguignonne, and hot pot, each of the plurality of heating settings including a unique predefined temperature curve.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An induction heating system comprising:
an induction heater;
a user interface for setting a desired temperature value of induction heater;
a cooking vessel formed of an induction-compatible material and including a base, an exterior wall, and an interior surface;
a control system configured to:
receive the desired temperature value of the induction heater;
estimate an actual temperature value of the cooking vessel;
compare the estimated temperature value with the desired temperature value; and
if a difference between the estimated and desired temperature values is outside of a predetermined threshold, adjust the induction heater until the difference between the estimated and desired temperature values is within the predetermined threshold.

2. The induction heating system of claim 1, wherein the control system includes a heating setting for at least one of chocolate fondue, cheese fondue, bourguignonne, and hot pot.

3. The induction heating system of claim 2, wherein the control system includes a processor and a memory, the memory containing instructions for the heating setting that, when executed by the processor, cause the processor to adjust the induction heater in accordance with the heating setting.

4. The induction heating system of claim 3, wherein the instructions for the heating setting include a predefined temperature curve that has a rate of adjusting the induction heater.

5. The induction heating system of claim 3, wherein the heating setting includes a plurality of heating settings for two or more of the chocolate fondue, cheese fondue, bourguignonne, and hot pot.

6. The induction heating system of claim 1, further including a table that includes a pocket, wherein the induction heater is located in the pocket.

7. The induction heating system of claim 6, wherein the pocket is sized to accommodate the base of the cooking vessel.

8. The induction heating system of claim 6, wherein a perimeter of the table is round.

9. The induction heating system of claim 1, wherein the interior surface of the cooking vessel includes a non-stick coating.

10. An induction heating system comprising:
an induction heater;
a cooking vessel formed of an induction-compatible material and including a base, an exterior wall, and an interior surface;
a processor and a memory, the memory containing at least one heating setting for at least one of chocolate fondue, cheese fondue, bourguignonne, and hot pot that, when executed by the processor, cause the processor to:
estimate an actual temperature value of the cooking vessel; and
adjust the induction heater in accordance with the at least one heating setting.

11. The induction heating system of claim 10, wherein the at least one heating setting includes a maximum temperature, and the processor prevents the induction heater from exceeding the maximum temperature.

12. The induction heating system of claim 11, wherein the at least one heating setting includes a chocolate fondue heating setting with an optimal setting of about 45° C. and a user interface configured to allow a user to adjust the temperature within a range of about 5° C. above and below the optimal setting.

13. The induction heating system of claim 11, wherein the at least one heating setting includes a cheese fondue heating setting with an optimal setting of about 40° C. to 45° C. and a user interface configured to allow a user to adjust the temperature within a range of about 5° C. above and below the optimal setting.

14. The induction heating system of claim 10, wherein the at least one heating setting includes a hot pot heating setting with an optimal setting of about 93° C. to 98° C. and a user interface configured to allow a user to adjust the temperature within a range of about 5° C. above and below the optimal setting.

15. The induction heating system of claim 10, wherein the at least one heating setting includes a predefined temperature curve that has a melting segment and a maintenance segment, the melting segment including a higher temperature than the maintenance segment.

16. The induction heating system of claim 10, further including a table defining an outer perimeter that includes a pocket located substantially centrally within the outer perimeter and the induction heater is located in the pocket.

17. An induction heating system comprising:
an induction heater;
a user interface for setting a desired temperature value associated with at least one heating setting of the induction heater;
a cooking vessel formed of an induction-compatible material and including a base, an exterior wall, and an interior surface;
a processor and a memory, the memory containing the least one heating setting for at least one of chocolate fondue, cheese fondue, bourguignonne, and hot pot that, when executed by the processor, cause the processor to:
compare the estimated temperature value with the desired temperature value; and
if a difference between the estimated and desired temperature values is outside of a predetermined threshold, adjust the induction heater until the difference between the estimated and desired temperature values is within the predetermined threshold.

18. The induction heating system of claim 17, wherein the at least one heating setting includes a predefined temperature curve that has a warming segment and a maintenance segment, the warming segment including a higher temperature than the maintenance segment.

19. The induction heating system of claim 18, wherein the at least one heating setting includes a cheese fondue heating setting and a chocolate fondue heating setting and the warming segment is associated with melting and the maintenance segment is associated with maintaining the cheese or chocolate in a melted state.

20. The induction heating system of claim 18, wherein the at least one heating setting includes a plurality of heating settings for two or more of the chocolate fondue, cheese fondue, bourguignonne, and hot pot, each of the plurality of heating settings including a unique predefined temperature curve.
